(19) United States
(12) Patent Application Publication
(10) Pub. No.: US 2025/0034315 A1
(43) Pub. Date: Jan. 30, 2025

(54) POLYURETHANE COMPOSITION

(71) Applicant: HUNTSMAN PETROCHEMICAL LLC, The Woodlands, TX (US)

(72) Inventors: Min WU, Shanghai (CN); Yide LIANG, Shanghai (CN); Renjie JI, Shanghai (CN); Yi ZHANG, Shanghai (CN); Feng PAN, Shanghai (CN)

(21) Appl. No.: 18/718,458

(22) PCT Filed: Dec. 13, 2022
(86) PCT No.: PCT/US2022/052697

§ 371 Date: Jun. 11, 2024

(30) Foreign Application Priority Data
Dec. 14, 2021 (WO) PCT/CN2021/137719

(51) Int. Cl. C08G 18/18; C08G 18/32; C08G 18/66; C08G 18/76; C08L 75/04

(52) U.S. Cl. CPC C08G 18/1833; C08G 18/3275; C08G 18/6688; C08G 18/7607; C08G 18/7621; C08G 18/7664; C08L 75/04; C08G 2110/0008; C08G 2110/0083

(57) ABSTRACT

Polyurethane foam compositions having reduced odor and methods for producing the same are provided. The polyurethane foam compositions can include (a) a polyfunctional isocyanate; (b) an isocyanate reactive composition; and (c) an amine catalyst.

### CROSS REFERENCE TO RELATED APPLICATIONS

This application claims priority to PCT application number PCT/CN2021/137719 filed Dec. 14, 2021. The noted application is incorporated herein by reference.

### FIELD OF THE INVENTION

The present disclosure relates generally to polyurethane compositions with reduced odor and more specially to polyurethane compositions useful in polyurethane foams.

### BACKGROUND INFORMATION

Methods of preparing polyurethane (PU) or polyurea compositions by using tertiary amine catalysts are already known in the art. GB1287181 discloses the use of tertiary amines as catalysts in the manufacture of urethane foams. However, GB1287181 fails to determine if there are tertiary amines which can reduce odor in the PU foams. CN1898289 discloses the use of tertiary amine terminated polyols in the manufature of polyurethane foams. However, CN1898289 fails to deterimine if there are tertiary amine terminated polyols which can reduce odor in the polyurethane foams while still having good reactivity.

Despite the state of the art listed above, there is a continuous need for the development of a polyurethane composition useful in polyurethane foams, which has good reactivity and can significantly reduce odor.

### SUMMARY OF THE INVENTION

It has now been surprisingly found that the compositions and processes of the present disclosure provide a PU foam having a reduced odor. Advantages of the PU composition described in the present disclosure may include: (1) reduced odor emission; (2) good reactivity; and (3) little to no influence on the mechanical properties of the foam.

The present disclosure is concerned with compositions with reduced odor emission and processes for preparing these compositions. In one embodiment, the disclosure provides a polyurethane composition comprising: (a) a polyfunctional isocyanate; (b) an isocyanate reactive composition; and (c) a catalyst comprising a compound of the formula:

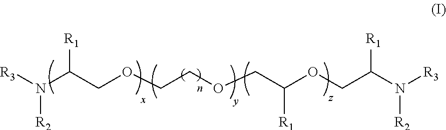

wherein
R₁ is a methyl or an ethyl group,
R₂ and R₃ are individually selected from an unsubstituted or substituted
alkyl, alkenyl, aryl, alkylaryl, or alkoxy group,
n=1, 2 or 3, and
x+y+z is from 8 to 25.

In another embodiment, the present disclosure provides a process for preparation of the polyurethane compositions.

In still another embodiment, the present disclosure provides a method of using the polyurethane compositions to form an interior part of a means of transport.

### DETAILED DESCRIPTION

If appearing herein, the term “comprising” and derivatives thereof are not intended to exclude the presence of any additional component, step or procedure, whether or not the same is disclosed herein. In order to avoid any doubt, all compositions claimed herein through use of the term “comprising” may include any additional additive, adjuvant, or compound, unless stated to the contrary. In contrast, the term, “consisting essentially of” if appearing herein, excludes from the scope of any succeeding recitation any other component, step or procedure, excepting those that are not essential to operability and the term “consisting of”, if used, excludes any component, step or procedure not specifically delineated or listed. The term “or”, unless stated otherwise, refers to the listed members individually as well as in any combination.

The articles “a” and “an” are used herein to refer to one or to more than one (i.e., to at least one) of the grammatical object of the article. By way of example, “a resin” means one resin or more than one resin.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phrases do not necessarily refer to the same embodiment.

If the specification states a component or feature “may”, “can”, “could”, or “might” be included or have a characteristic, that particular component or feature is not required to be included or have the characteristic.

The present disclosure generally provides a polyurethane composition comprising: (a) a polyfunctional isocyanate; (b) an isocyanate reactive composition; and (c) a catalyst comprising a compound of the formula:

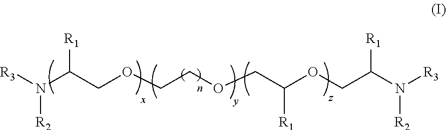

wherein
R₁ is a methyl or an ethyl group,
R₂ and R₃ are individually selected from an unsubstituted or substituted
alkyl, alkenyl, aryl, alkylaryl, or alkoxy group,
n=1, 2 or 3, and
x+y+z is from 8 to 25.

According to one embodiment, the polyfunctional isocyanate includes those represented by the formula Q(NCO)ₘ where m is a number from 2-5, preferably 2-3 and Q is an aliphatic hydrocarbon group containing 2-18 carbon atoms, a cycloaliphatic hydrocarbon group containing 5-10 carbon atoms, an araliphatic hydrocarbon group containing 8-13 carbon atoms, or an aromatic hydrocarbon group containing 6-15 carbon atoms, wherein aromatic hydrocarbon groups are in general preferred.

Examples of polyfunctional isocyanates include, but are not limited to, ethylene diisocyanate; 1,4-tetramethylene diisocyanate; 1,6-hexamethylene diisocyanate; 1,12-dodecane diisocyanate; cyclobutane-1,3-diisocyanate; cyclohexane-1,3- and -1,4-diisocyanate, and mixtures of these isomers; isophorone diisocyanate; 2,4- and 2,6-hexahydrotoluene diisocyanate and mixtures of these isomers; dicyclohexylmethane-4,4′-diisocyanate (hydrogenated MDI or HMDI); 1,3- and 1,4-phenylene diisocyanate; 2,4- and 2,6-toluene diisocyanate and mixtures of these isomers (TDI); diphenylmethane-2,4′- and/or -4,4′-diisocyanate (MDI); naphthylene-1,5-diisocyanate; triphenylmethane-4,4′,4″-triisocyanate; polyphenyl-polymethylene-polyisocyanates of the type which may be obtained by condensing aniline with formaldehyde, followed by phosgenation (polymeric MDI); norbornane diisocyanates; m- and p-isocyanatophenyl sulfonylisocyanates; perchlorinated aryl polyisocyanates; modified polyfunctional isocyanates containing carbodiimide groups, urethane groups, allophonate groups, isocyanurate groups, urea groups, or biruret groups; polyfunctional isocyanates obtained by telomerization reactions; polyfunctional isocyanates containing ester groups; and polyfunctional isocyanates containing polymeric fatty acid groups. Those skilled in the art will recognize that it is also possible to use mixtures of the polyfunctional isocyanates described above, preferably using mixture of polymeric MDI, mixture of MDI isomers and mixture of TDI.

In another embodiment, prepolymers of MDI or TDI can also be used as an alternative of MDI or TDI. Prepolymers of MDI or TDI are prepared by the reaction of an MDI or TDI and a polyfunctional polyol. The synthesis processes of prepolymers of MDI or TDI are known in the art (see for example Polyurethanes Handbook 2^{nd} edition, G. Oertel, 1994).

The isocyanate reactive composition suitable for use in the present disclosure may include polyfunctional polyol or polyfunctional amine.

The polyfunctional polyols for use in the present disclosure may include, but are not limited to, polyether polyols, polyester polyols, biorenewable polyols, polymer polyols, a non-flammable polyol such as a phosphorus-containing polyol or a halogen-containing polyol. Such polyols may be used alone or in suitable combination as a mixture. The general functionality of polyfunctional polyols used in the present disclosure is from 2 to 6. The molecular weight of polyols may be in an amount ranging from 200 to 10,000, preferably from 400 to 7,000. Molecular weight (MW) is weight average molecular weight which is defined by Gel Permeation Chromatography (GPC) method with polystyrene as a reference.

The proportion of said polyfunctional polyols is generally in an amount ranging from 10% to 90% by weight, preferably from 30% to 80% based on the polyurethane composition.

Polyether polyols for use in the present disclosure include alkylene oxide polyether polyols such as ethylene oxide polyether polyols and propylene oxide polyether polyols and copolymers of ethylene and propylene oxide with terminal hydroxyl groups derived from polyhydric compounds, including diols and triols; for example, ethylene glycol, propylene glycol, 1,3-butane diol, 1,4-butane diol, 1,6-hexane diol, neopentyl glycol, diethylene glycol, dipropylene glycol, pentaerythritol, glycerol, diglycerol, trimethylol propane, and similar low molecular weight polyols.

Polyester polyols for use in the present disclosure include, but are not limited to, those produced by reacting a dicarboxylic acid with an excess of a diol, for example, adipic acid with ethylene glycol or butanediol, or reaction of a lactone with an excess of a diol such as caprolactone with propylene glycol. In addition, polyester polyols for use in the present disclosure may also include: linear or lightly branched aliphatic (mainly adipates) polyols with terminal hydroxyl group; low molecular weight aromatic polyesters; polycaprolactones; polycarbonate polyol. Those linear or lightly branched aliphatic(mainly adipates) polyols with terminal hydroxyl group are produced by reacting a dicarboxyl acids with an excess of diols, triols and their mixture; those dicarboxyl acids include, but are not limited to, for example, adipic acid, AGS mixed acid; those diols, triols include, but are not limited to, for example, ethylene glycol, diethylene glycol, propylene glycol, dipropylene glycol, 1,4-butane diol, 1,6-hexane diol, glycerol, trimethylolpropane and pentaerythritol. Those low molecular weight aromatic polyesters include products derived from the process residues of dimethyl terephalate (DMT) production, commonly referred to as DMT still bottoms, products derived from the glycolysis of recycled poly(ethyleneterephthalate) (PET) bottles or magnetic tape with subsequent re-esterification with di-acids or reaction with alkylene oxides, and products derived by the directed esterification of phthalic anhydride. Polycaprolactones are produced by the ring opening of caprolactones in the presence of an initiator and catalyst. The initiator includes ethylene glycol, diethylene glycol, propylene glycol, dipropylene glycol, 1,4-butane diol, 1,6-hexane diol, glycerol, trimethylolpropane and pentaerythritol. Polycarbonate polyols are derived from carbonic acid that can be produced through the polycondensation of diols with phosgene, although transesterification of diols, commonly hexane diol, with a carbonic acid ester, such as diphenylcarbonate.

Biorenewable polyols suitable for use in the present disclosure include castor oil, sunflower oil, palm kernel oil, palm oil, canola oil, rapeseed oil, soybean oil, corn oil, peanut oil, olive oil, algae oil, and mixtures thereof.

Examples of polyfunctional polyols also include, but are not limited to, graft polyols or polyurea modified polyols. Graft polyols comprise a triol in which vinyl monomers are graft copolymerized. Suitable vinyl monomers include, for example, styrene, or acrylonitrile. A polyurea modified polyol, is a polyol containing a polyurea dispersion formed by the reaction of a diamine and a diisocyanate in the presence of a polyol. A variant of polyurea modified polyols are polyisocyanate poly addition (PIPA) polyols, which are formed by the in situ reaction of an isocyanate and an alkanolamine in a polyol.

The non-flammable polyol may, for example, be a phosphorus-containing polyol obtainable by adding an alkylene oxide to a phosphoric acid compound. A halogen-containing polyol may, for example, be those obtainable by ring-opening polymerization of epichlorohydrin or trichlorobutylene oxide.

The polyfunctional amine for use in the present disclosure may include polyether polyamine or polyester polyamine.

In a preferred embodiment, the isocyanate reactive composition is polyether polyol.

It has been found that many compounds which can be used to decrease emissions in the formation of polyurethane foams are ineffective in decreasing odor. However, adding component (c), indicated above, to the polyurethane composition of the present disclosure was found to reduce the odor emission.

Component (c) is used as catalyst in the formation of the polyurethane foam. Catalysts which are suitable for use in the present reactive composition can include an amine catalyst based on polyetheramine structure of the formula:

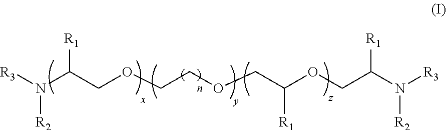

wherein
R₁ is a methyl or an ethyl group,
R₂ and R₃ are individually selected from an unsubstituted or substituted
alkyl, alkenyl, aryl, alkylaryl, or alkoxy group,
n=1, 2 or 3, and
x+y+z is from 8 to 25.

In embodiments of the present disclosure, the compound of formula (I) may be prepared by methlation of polyether amine. Examples of polyether amines include polyether amine products from Huntsman Corporation such as polypropylene glycol bis(aminopropyl) ether (Jeffamine®D230 amine, Jeffamine®D400 amine, Jeffamine®D1000 amine, and Jeffamine®D2000 amine), 2-[2-(2-Aminoethoxy)ethoxy]ethylamine (Jeffamine®EDR148 amine), 1,2-Bis(3-aminopropoxy)ethane (Jeffamine®EDR176 amine), and poly(oxyethylene-oxypropylene) bis(aminopropyl) ether (Jeffamine®ED600 amine, Jeffamine®ED900 amine, and Jeffamine®ED2003 amine), amines obtained by adducting polyether amine or polyethylene amine with urea or a guanidine compound, such as the amine obtained by reacting guanidine with TETA, and amines obtained from the Michael Addition reaction of an alcohol containing or amino containing tertiary amine followed by hydrogenation, such as the amine obtained by reacting DMAPA with acrylonitrile followed by hydrogenation, and the amine obtained by reacting DMEA (dimethylaminoethanol) with acrylonitrile followed by hydrogenation.

In another embodiment, tri-functional methylated polyether amines can also be used as an alternative of bi-functional methylated polyether amines. Tri-functional methylated polyether amines are prepared by methlation of tri-functional polyether amine. The synthesis processes of tri-functional methylated polyether amines are known in the art and similar to the synthesis processes of bi-functional methylated polyether amines. The preferred molecular weight of tri-functional methylated polyether amine is between 300 and 3000 and more preferred between 600 and 1000.

The ratio of component (b) to component (c) presented by weight percentage in the polyurethane composition is in an amount ranging from about 10:1 to about 2000:1, preferably from about 20:1 to about 1500:1, and more preferably from about 50:1 to about 1000:1.

According to one embodiment, the NCO index of the polyurethane composition is in the range of from 0.6 to about 4, preferably from about 0.7 to about 1.3. The isocyanate index or NCO index or index is the ratio of NCO-groups over isocyanate-reactive hydrogen atoms present in a formulation, as shown in equation (1) [NCO]/[active hydrogen]. In other words, the NCO-index expresses the amount of isocyanate actually used in a formulation with respect to the amount of isocyanate theoretically required for reacting with the amount of isocyanate-reactive hydrogen used in a formulation.

In another embodiment, the polyurethane composition may further optionally comprise fire retardants, antioxidants, surfactants, physical or chemical blowing agents, chain extender, crosslinking agent, foam stabilizer, fillers, pigments, or any other typical additives used in PU materials.

Advantages of the disclosed composition may include: (1) reduced odor emission; (2) good reactivity; and (3) no obvious influence on the mechanic properties of the foam.

The present disclosure also provides a process for making the polyurethane composition, comprising mixing components (b) and (c) to form a mixture, and adding the mixture to component (a).

Furthermore, the present disclosure also provides the method of using the polyurethane composition to form an interior part of a means of transport, preferably an interior cladding of automobiles such as roof cladding, carpet-backing foam, door cladding, steering rings, control knobs and seat cushioning.

Embodiments of the present disclosure can also be applied in other industry areas where the PU foams are used, such as furniture, bedding, construction, footwear, etc. The PU foam includes flexible PU foam, semirigid PU foam, rigid PU foam, viscoelastic PU foam, integral skin PU foam, hydroponic PU foam and alike.

### EXAMPLES

The examples which now follow should be considered exemplary of the present disclosure, and not limiting thereof in any way.

### Raw Materials

Polyfunctional Isocyanate: mixture of 80 parts by weight of DESMODUR® T 80 TDI (Commercially available from: Covestro) and 20 parts by weight of SUPRASEC® 5005 polymeric MDI (Commercially available from: Huntsman Corporation, USA);
Polyol A: NJ-360V polyether polyol with OH number 28 mgKOH/g (Commercially available from: Ningwu New Material Development Co., China);
Polyol B: KONIX® KE-880S polyether polyol with OH number 20 mgKOH/g (Commercially available from: KPX, Korea);
Foam Stabilizer: TEGOSTAB® B8738 LF2 polymer additive (siloxane based surfactant). (Commercially available from: Evonik);
Blowing Agent: JEFFCAT® ZF-10 catalyst (N,N,N′-trimethyl-N′-(2-hydroxyethyl)bis(2-aminoethyl)ether) (Commercially available from: Huntsman Corporation, USA);
Chain Extender: diethanolamine (DEOA);
PPG-600: polypropylene glycol with molecular weight of 600;
Catalyst G: JEFFCAT® DPA catalyst (N,N-Dimethyl-N′,N′-di(2-hydroxypropyl)-1,3-propylenediamine) (Commercially available from: Huntsman Corporation, USA);
Catalyst H: RZETA® HD catalyst (1,4-Diazabicyclo[2.2.2]octane-2-methanol) (Commercially available from: Tosoh, Japan).

### Preparing of Polyether Amine A

PPG-600, Raney Nickel, liquid ammonia and hydrogen were mixed in the proportion (by mole of molecules) of 1:0.01:10:5 to a 600 ml reactor, equipped with mechanical stirrer, thermometer and reflux condenser at 200° C. and under total pressure of 150 bar. the mixture was stirred for another 10 hours. The reaction mixture was vacuumed under 10 torr at 90° C. for about 2 hours until the amine value was less than 3.36 mequiv/g to obtain a polyether amine.

### Preparing of Catalyst A to F

Polyetheramine, Raney Nickel, formaldehyde and hydrogen were mixed in the proportion (by mole of molecules) of 1:0.01:6:10 to a 600 ml autoclave, equipped with mechanical stirrer, thermometer and reflux condenser at 120° C. and under total pressure of 10 bar. the mixture was stirred for another 4 hours and digested for 4 hours. The reaction mixture was vacuumed at 110° C. for about 6 hours to obtain an inventive catalyst.

The polyetheramine used for preparing Catalyst A to F has a structure of the formula (I):

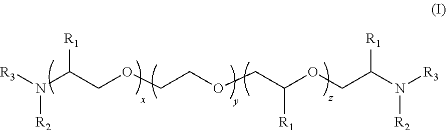

wherein R₁, R₂, R₃, x, y, and z are defined in Table 1:

TABLE 1

| | polyetheramine used for | | | | |
|---|---|---|---|---|---|
| Catalyst | preparing Catalyst | R₁ | R₂ | R₃ | x + y + z |
| A | Polyether Amine A | methyl | methyl | methyl | 10 |
| B | JEFFAMINE ® ED-600 | methyl | methyl | methyl | 12 |
| C | JEFFAMINE ® D-1000 | methyl | methyl | methyl | 17 |
| D | JEFFAMINE ® D-230 | methyl | methyl | methyl | 4 |
| E | JEFFAMINE ® D-400 | methyl | methyl | methyl | 7 |
| F | JEFFAMINE ® D-2000 | methyl | methyl | methyl | 34 |

### Examples 1-12

Examples 1-12 were produced with the Polyfunctional Isocyanate as the A Component. The B Components for Examples 1 through 12 are shown in Table 2. All values listed in Table 2 refer to parts by weight of the B Component. As shown in Table 2, Examples 1 and 2 were comparative examples that contained a catalyst not from the present disclosure. Examples 7 and 8 were comparative examples that contained a catalyst with lower molecular weight than the ones of the present disclosure. Example 12 is a comparative example that contained a catalyst with higher molecular weight than the ones of the present disclosure.

TABLE 2
B

| Component | Example | | | | | | | | | | | |
|---|---|---|---|---|---|---|---|---|---|---|---|---|
| Formulation | 1 | 2 | 3 | 4 | 5 | 6 | 7 | 8 | 9 | 10 | 11 | 12 |
| Polyol A | 100 | 100 | 100 | 100 | 100 | 100 | 100 | 100 | 100 | 100 | 100 | 100 |
| Polyol B | 42.8 | 42.8 | 42.8 | 42.8 | 42.8 | 42.8 | 42.8 | 42.8 | 42.8 | 42.8 | 42.8 | 42.8 |
| Chain | 1.43 | 1.43 | 1.43 | 1.43 | 1.43 | 1.43 | 1.43 | 1.43 | 1.43 | 1.43 | 1.43 | 1.43 |
| Extender | | | | | | | | | | | | |
| Foam | 1 | 1 | 1 | 1 | 1 | 1 | 1 | 1 | 1 | 1 | 1 | 1 |
| Stabilizer | | | | | | | | | | | | |
| water | 5 | 5 | 5 | 5 | 5 | 5 | 5 | 5 | 5 | 5 | 5 | 5 |
| Blowing | 0.21 | 0.21 | | 0.21 | | 0.21 | 0.21 | 0.21 | 0.21 | 0.21 | 0.21 | 0.21 |
| Agent | | | | | | | | | | | | |
| Catalyst A | | | | | 1.86 | 1.43 | | | | 0.93 | | |
| Catalyst B | | | 1.86 | 1.43 | | | | | 0.93 | | | |
| Catalyst C | | | | | | | | | | | 0.93 | |
| Catalyst D | | | | | | | 0.93 | | | | | |
| Catalyst E | | | | | | | | 0.93 | | | | |
| Catalyst F | | | | | | | | | | | | 0.93 |
| Catalyst G | 0.93 | | | | | | | | | | | |
| Catalyst H | | 1.43 | | | | | | | | | | |

### Procedure

For Examples 1-12, the A and B Components were mixed in the proportion (by weight) of A:B=43:100 and at an index of 1.05 and stirred in a polyethylene container to make the polyurea/polyurethane foam. The resulting foam composition was rapidly poured into a polyethylene bag. A foaming reaction proceeded and the foam was allowed to free rise. The foams are cured for a minimum of 15 minutes at room temperature before being tested, for each formulation about 1 kilogram (kg) foam was made via hand mix foam procedure for VDA270 odor test and VDA278 emission test. The temperature of the test chamber during the odor test was 80° C. The temperature of the test chamber during the emission test was 90° C. in VOC and 120° C. in Fog. VDA270 (2018/06 edition) and VDA278 (2016/05 edition) are test methods from the Verband der Automobilindustrie (website: https://www.vda.de/de).

### Results

### Odor Panel of PU Foam

TABLE 3

| | Example | | | | | | | |
|---|---|---|---|---|---|---|---|---|
| Panel ¹⁾ | 1 | 2 | 3 | 4 | 5 | 6 | 7 | 8 |
| 1 | 3 | 3 | 2.5 | 2.5 | 2.5 | 2.5 | 2.5 | 2 |
| 2 | 3.5 | 3 | 3 | 3 | 3 | 3 | 2.5 | 2.5 |
| 3 | 3.5 | 3 | 2.5 | 3 | 3 | 2.5 | 2 | 2 |
| Average | 3.33 | 3 | 2.67 | 2.83 | 2.83 | 2.67 | 2.33 | 2.17 |

¹⁾ Tested according to VDA270
Odor test Method VDA-270
Test vessel is placed inside testing chamber and subjected to specific temperature for determined duration. Sample material is assigned a variant based on their location in the vehicle, and placed inside odor-neutral, sealed test vessel.
Variants 1 and 2: 50 ml of deionized water added to test vessel, immediate evaluation upon removal from chamber;
Variant 3: no water added to test vessel, cooled to a temperature of (60 ± 5)° C. prior to evaluation.
After evaluation by three testers, the vessel is stored again at a temperature of (80 ± 2)° C. prior to evaluation by other testers.
Assessor smells and evaluates the intensity of the odor5.
An evaluation using a 6-grade scale ranging from not perceptible to not acceptable is submitted.
Note:
1 = not perceptible
2 = perceptible, but not disturbing
3 = clearly perceptible, but not disturbing
4 = disturbing
5 = strongly disturbing
6 = not acceptable

Table 3 shows the odor emission for Examples 1-8 as tested according to the VDA270 emission test. As indicated in Table 3, when methylated polyether amine catalysts are present in the PU foam composition (Examples 3-8), there is a significant reduction in odor emission.

### Physical Property

TABLE 4

| Example | 1 | 4 | 6 | 7 | 8 | 9 |
|---|---|---|---|---|---|---|
| Molded density ²⁾ | 40 | 38 | 37 | 39 | 39 | 39 |
| [kg/m³] | | | | | | |
| Tensile ²⁾ [kpa] | 130 | 134 | 106 | 122 | 118 | 120 |
| Tear ²⁾ [N/m] | 237 | 244 | 300 | 251 | 304 | 275 |
| Elongation ²⁾ [%] | 101 | 94 | 100 | 84 | 82 | 84 |
| Dry Compression Set ²⁾ [%] | 8.0 | 6.1 | 6.7 | 9.1 | 7.4 | 8 |
| Wet compression set @ 50° C./ | 33.0 | 25.8 | 35.6 | 33.7 | 27.8 | 30.0 |
| 95% RH ²⁾ [%] | | | | | | |
| Rebound ²⁾ [%] | 66 | 60 | 65 | 65 | 65 | 65 |
| Indentation Force Deflection | 161 | 110 | 122 | 148 | 145 | 147 |
| (IFD) 25% ²⁾ [N] | | | | | | |
| IFD 65% ²⁾ [N] | 468 | 369 | 429 | 507 | 483 | 500 |
| Support Factor | 2.90 | 3.35 | 3.52 | 3.43 | 3.33 | 3.40 |
| Compression Force Deflection | 4.4 | 3.2 | 3.5 | 5.5 | 4.8 | 5.0 |
| (CFD) ²⁾ [Kpa] | | | | | | |
| Air Flow ²⁾ | 1.22 | 1.25 | 1.34 | 1.11 | 1.22 | 1.17 |
| [dm³/s] | | | | | | |

²⁾ Tested according to ASTM D3574
ASTM D3574 are the Standard Test Methods for Flexible Cellular Materials-Slab, Bonded, and Molded Urethane Foams which is issued by ASTM International, formerly known as American Society for Testing and Materials, is an international standards organization. These test methods apply to slab, bonded, and molded flexible cellular products known as urethane foams. Urethane foam is generally defined as an expanded cellular product produced by the interaction of active hydrogen compounds, water, and isocyanates. The Dry compression set is tested by a Compression Device, consisting of two or more flat plates arranged so the plates are held parallel to each other by bolts or clamps and the space between the plates is adjustable to the required deflection thickness by means of spacers. Place the test specimen in the apparatus and deflect it to 50 ± 1% of its thickness, place the deflected specimen and the apparatus in the mechanically convected air oven at 70° C. and 6% maximum relative humidity for a period of 22 hours, and then remove the apparatus. Remove the specimen immediately from the apparatus and measure the final thickness after allowing it to recover 30 to 40 minutes.

Table 4 shows the physical property for Examples 1, 4, 6-9. When catalysts described in the present disclosure are present (Examples 4, 6 and 9), there is a no obvious influence on the mechanical properties of the foam.

### Amine Emission

TABLE 5

| | Example | | | |
|---|---|---|---|---|
| | 4 | 6 | 7 | 8 |
| Amine emission in VOC ³⁾ [ppm] | 8.43 | 1.98 | 1468.91 | 1451.34 |
| Amine emission in Fog ³⁾ [ppm] | 19.26 | 23.54 | 1001.24 | 2159.89 |

³⁾ Tested according to VDA278
VDA 278 Thermal Desorption Analysis of Organic Emissions for the Characterization of Non-Metallic Materials for Automobiles. The materials are characterized with regard to the type and quantity of the organic substances out gassed from them. In this method two semi-quantitative cumulative values are determined which allow the emission of volatile organic compounds (VOC value) and the portion of condensable substances (FOG value) to be estimated. Furthermore, single substance emissions (such as amine emissions) are determined. During the analysis, the samples are thermally extracted, and the emissions are separated by gas chromatography and detected by mass spectrometry. The said volatile organic compounds are out gassed at 90° C., the said condensable substances are out gassed at 120° C.

Table 5 shows the amine emission for Examples 4, 6, 7 and 8 as tested according to the VDA278 emission test. Examples 4 and 6 of the present disclosure show a reduction of amine emission over Example 7 and 8 (contained a catalyst with lower molecular weight than those made in accordance with the present disclosure).

### Reactivity of PU Foam

TABLE 6

| Example | 1 | 7 | 8 | 9 | 10 | 11 | 12 |
|---|---|---|---|---|---|---|---|
| Cream Time ⁴⁾ | 9 | 8 | 8 | 8 | 9 | 10 | 10 |
| [second] | | | | | | | |
| Top of Cup Time ⁴⁾ | 39 | 29 | 36 | 42 | 43 | 50 | 68 |
| [second] | | | | | | | |
| String Gel Time ⁴⁾ | 72 | 67 | 81 | 80 | 97 | 120 | 154 |
| [second] | | | | | | | |
| Rise Time ⁴⁾ | 147 | 112 | 158 | 158 | 162 | 165 | 195 |
| [second] | | | | | | | |
| Tack Free Time ⁴⁾ | 570 | 480 | 580 | 700 | 710 | 1000 | 1200 |
| [second] | | | | | | | |

⁴⁾ Cream time is defined as the time from the preparation of the reaction mixture until the recognizable beginning of the foaming mixture.
Top of cup time is defined as the time from the preparation of the reaction mixture until the height of foam reach the cup top.
String gel time is defined as the time from the preparation of the reaction mixture until the transition from the fluid to the solid state is reached.
Rise time is defined as the time from the preparation of the reaction mixture until the height of the foam does not growth anymore.
All the above were assessed visually.
Tack-free time is defined as the time from the preparation of the foam reaction mixture until the surface of the foam is tack free.

Table 6 shows the reactivity of PU foam for Examples 1, 7-12. Example 12 that contained a catalyst with higher molecular weight than the ones of the present disclosure shows very poor reactivity.

From the above description, it is clear that the present disclosure is well adapted to attain the advantages mentioned herein as well as those inherent in the present disclosure. While exemplary embodiments of the present disclosure have been described for the purposes of the disclosure, it will be understood that numerous changes may be made which will readily suggest themselves to those skilled in the art which can be accomplished without departing from the scope of the present disclosure and the appended claims.

1. A polyurethane composition comprising:
(a) a polyfunctional isocyanate;
(b) an isocyanate reactive composition; and
(c) a catalyst comprising a compound of the formula: 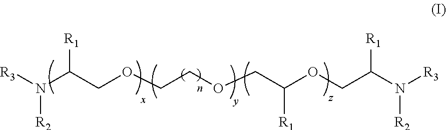
wherein
R₁ is a methyl or an ethyl group,
R₂ and R₃ are individually selected from an unsubstituted or substituted alkyl, alkenyl,
aryl, alkylaryl, or alkoxy group,
n=1, 2 or 3, and
x+y+z is from 8 to 25.

2. The polyurethane composition of claim 1, wherein the polyurethane composition has an NCO index in a range of from about 0.6 to about 4.

3. The polyurethane composition of claim 2, wherein the NCO index is in the range from about 0.7 to about 1.3.

4. The polyurethane composition of claim 1, wherein the polyfunctional isocyanate is selected from a polymeric methylene diphenyl diisocyanate, a methylene diphenyl diisocyanate isomer mixture, a toluene diisocyanate isomer mixture and a mixture thereof.

5. The polyurethane composition of claim 1, wherein the isocyanate reactive composition comprises a polyfunctional polyol or a polyfunctional amine.

6. The polyurethane composition of claim 5, wherein the isocyanate reactive composition comprises a polyfunctional polyol.

7. The polyurethane composition of claim 6, wherein the polyfunctional polyol is a polyether polyol.

8. The polyurethane composition of claim 1, wherein R₂ and R₃ are individually selected from a methyl group or an ethyl group.

9. The polyurethane composition of claim 1, wherein n=1.

10. The polyurethane composition of claim 1, wherein n=2 or 3.

11. The polyurethane composition of claim 1, wherein x+y+z is from 8 to 15.

12. The polyurethane composition of claim 1, wherein the ratio of component (b) to component (c) presented by weight percentage in the polyurethane composition is in an amount ranging from about 10:1 to about 2000:1

13. The polyurethane composition of claim 12, wherein the ratio of component (b) to component (c) is in an amount ranging from about 20:1 to about 1500:1.

14. The polyurethane composition of claim 13, wherein the ratio of component (b) to component (c) is in an amount ranging from about 50:1 to about 1000:1.

15. The polyurethane composition of claim 1, wherein the polyurethane composition further comprises at least one chain extender.

16. The polyurethane composition of claim 15, further comprising one or more of a fire retardant, an antioxidant, a surfactant, a physical or chemical blowing agent, a crosslinking agent, a foam stabilizer, a filler or a pigment.

17. A process for making the polyurethane composition of claim 1 comprising mixing components (b) and (c) to form a mixture, and mixing the mixture with component (a).

18. The process of claim 17, wherein component (a) comprises TDI, polymeric MDI or a mixture thereof and component (b) comprises a polyether polyol.

19. A method for reducing the odor of a polyurethane foam comprising reacting
(a) a polyfunctional isocyanate with
(b) an isocyanate reactive composition in the presence of
(c) a catalyst comprising a compound of the formula: 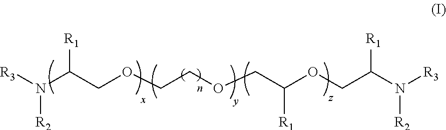
wherein
R₁ is a methyl or an ethyl group,
R₂ and R₃ are individually selected from an unsubstituted or substituted alkyl, alkenyl, aryl, alkylaryl, or alkoxy group,
n=1, 2 or 3, and
x+y+z is from 8 to 25.

20. A method of using the polyurethane composition of claim 1 to form an interior part of a means of transport.
